(19) United States
(12) Patent Application Publication
(10) Pub. No.: US 2009/0015381 A1
(43) Pub. Date: Jan. 15, 2009

(54) WIRELESS TAG READER/WRITER ANTENNA

(75) Inventors: Sadayoshi Mochida, Numazu-shi (JP); Hidekazu Mori, Mishima-shi (JP)

Correspondence Address: AMIN, TUROCY & CALVIN, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/042,597

(22) Filed: Mar. 5, 2008

(30) Foreign Application Priority Data
May 16, 2007 (JP) 2007-130581

(51) Int. Cl. H04Q 5/22

(52) U.S. Cl. 340/10.2

(57) ABSTRACT

A wireless tag reader/writer antenna according to an embodiment of this invention includes an antenna unit that incorporates a reader/writer antenna for transmitting and receiving electromagnetic waves to and from wireless tags; and a plurality of magnetic-wave shields that clamp the antenna unit and extend in a direction of radiating electromagnetic waves from the reader/writer antenna. The magnetic-wave shields are configured be provided to be detached or to slide. So configured, the magnetic-wave shields can effectively block electromagnetic waves that are detrimental to communication with the wireless tags.

### CROSS-REFERENCE TO RELATED APPLICATION

This application is based upon and claims the benefit of priority from the prior Japanese Patent Application No. 2007-130581, filed on May 16, 2007, the entire contents of which are incorporated herein by reference.

### BACKGROUND OF THE INVENTION

1. Field of the Invention

The present invention relates to a wireless tag reader/writer antenna having an antenna which comprises electromagnetic-wave shields for shielding a wireless tag reader/writer from electromagnetic waves that are detrimental to the communication with wireless tags and which transmits and receives electromagnetic waves to and from wireless tags.

2. Description of the Related Art

During communication with wireless tags, electromagnetic waves may exist, which interfere with the electromagnetic waves being transmitted to, or received from, wireless tags, as will be explained with reference to the following example.

FIG. 7A shows how communication is achieved between the wireless tags attached to documents 602 densely stuck in a metal shelf 601 and the wireless tag reader/writer 604 controlled by a higher-order apparatus 603, such as a personal computer, through a wireless tag reader/writer antenna 605. In this case, the wireless tag reader/writer antenna 605 may apply electromagnetic waves to the wireless tags at a position in the metal shelf 601 or a position very close to the shelf 601.

FIG. 7B is a diagram schematically showing how the electromagnetic waves emanating are reflected in the metal shelf 601. As shown in FIG. 7B, the electromagnetic waves emitted from the wireless tag reader/writer antenna 605 are reflected by the metal parts of the shelf 601 and are applied, as reflected waves 607, to the wireless tag reader/writer antenna 605. The reflected waves 607 inevitably interfere with the communication between each wireless tag 602 and the wireless tag reader/writer 604.

In regard to this, a technique of shielding wireless tags from electromagnetic waves detrimental to communication has been proposed (see, for example, Jpn. Pat. Appln. Laid-Open Publication No. 2005-266961). In the technique, a wireless tag reader/writer antenna is provided in a storing case that shields wireless tags from electromagnetic waves, and articles having wireless tags attached to them are stored in the storing case, whereby the wireless tags are shielded from electromagnetic waves.

Another technique of shielding a reader/writer from electromagnetic waves has been proposed (see, for example, Jpn. Pat. Appln. Laid-Open Publication No. 2005-175134). In this technique, a cover is attached to the antenna unit of a handy reader/writer in order to shield the reader/writer from electromagnetic waves and articles having a wireless tag each are inserted between the antenna unit and the cover. The reader/writer can thus be shielded from the electromagnetic waves detrimental to the communication.

Further, a technique of preventing the reflection of electromagnetic waves has been proposed (see, for example, Jpn. Pat. Appln. Laid-Open Publication No. 2000-137873). The technique is to bond a layer of material that absorbs electromagnetic waves to the inner surfaces of a metal case, thus preventing the reflection of electromagnetic waves at the metal parts.

Another technique of preventing the reflection of electromagnetic waves has been proposed (see, for example, Jpn. Pat. Appln. Laid-Open Publication No. 2002-64327). This technique is to bond a layer of material that absorbs electromagnetic waves to the walls and roofs of buildings, thus preventing the reflection of electromagnetic waves at the metal parts.

The techniques disclosed in Jpn. Pat. Appln. Laid-Open Publications Nos. 2005-266961 and 2005-175134 are disadvantageous, however. A number of articles having a wireless tag each must be taken out and inserted into the reader/writer, requiring much time and labor.

The technique disclosed in Jpn. Pat. Appln. Laid-Open Publications No. 2000-137873 is disadvantageous, too, because many layers of wave-absorbing material must be used to cover the inner surfaces of the metal case, inevitably raising the cost.

The technique disclosed in Jpn. Pat. Appln. Laid-Open Publication No. 2002-64327 is also disadvantageous in that the reflection of electromagnetic waves cannot be prevented within any metal case.

### BRIEF SUMMARY OF THE INVENTION

An object of the present invention is to provide a wireless tag reader/writer antenna that can efficiently shield a wireless tag reader/writer from electromagnetic waves that are detrimental to communication with wireless tags.

To achieve the object, a wireless tag reader/writer antenna according to an aspect of this invention includes: an antenna unit that incorporates a reader/writer antenna for transmitting and receiving electromagnetic waves to and from wireless tags; and a plurality of magnetic-wave shields that clamp the antenna unit and extend in a direction of radiating electromagnetic waves from the reader/writer antenna.

According to an aspect of the present invention, the wireless tag reader/writer can be efficiently shielded from electromagnetic waves detrimental to the communication with wireless tags by providing electromagnetic shields to the antenna unit. According to another aspect of this invention, an electromagnetic-wave shield can be detached and attached and can slide, enhancing the efficiency of handling articles that have a wireless tag each.

### BRIEF DESCRIPTION OF THE DRAWINGS

FIG. 1A is a perspective view of a wireless tag reader/writer antenna 101 according to a first embodiment of the present invention;

FIG. 1B is a side view of the wireless tag reader/writer antenna 101;

FIG. 1C is a top view of the wireless tag reader/writer antenna 101;

FIG. 1D is another top view of the wireless tag reader/writer antenna 101;

FIG. 2A is a sectional view of an electromagnetic-wave shield according to the first embodiment, as viewed from above, which comprises a metal layer 401 that uniformly reflects electromagnetic waves and an electromagnetic-wave absorbing layer 402 that is laid on the metal layer 401;

FIG. 2B is another sectional view of the electromagnetic-wave shield according to the first embodiment, as viewed from above, showing an electromagnetic-wave absorbing layer 403 that is a molding;

FIG. 3A is a perspective view of a wireless tag reader/writer antenna 201 according to a second embodiment of the present invention;

FIG. 3B is a magnified view of the junction of the antenna unit 202 and an electromagnetic-wave shield 203, both provided in the antenna 201;

FIG. 3C is a top view of the wireless tag reader/writer antenna 201;

FIG. 3D is a top view of another type of the wireless tag reader/writer antenna 201;

FIG. 4 is a magnified view of the junction of the antenna unit and an electromagnetic-wave shield of the wireless tag reader/writer antenna according to the second embodiment;

FIG. 5A is a perspective view of a wireless tag reader/writer antenna 801 according to a third embodiment of this invention;

FIG. 5B is a perspective view of another type of a wireless tag reader/writer antenna 811 according to the third embodiment;

FIG. 6 is a block diagram illustrating how a wireless tag reader/writer antenna is used;

FIG. 7A is a diagram explaining how a wireless tag reader/writer communicates with wireless tags in a conventional method;

FIG. 7B is a diagram schematically illustrating how electromagnetic waves are reflected; and

FIG. 8 is a diagram schematically showing an embodiment of the present invention.

### DETAILED DESCRIPTION OF THE INVENTION

A wireless tag reader/writer antenna according to an embodiment of this invention will be described in detail, with reference to the accompanying drawings.

### Outline of the Embodiment

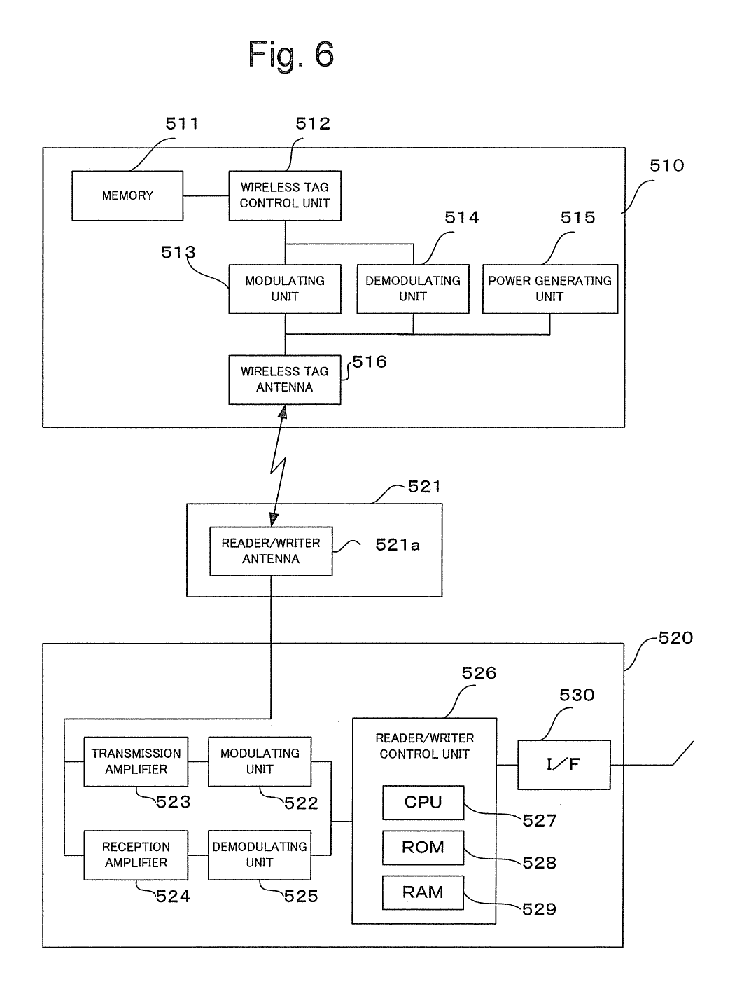

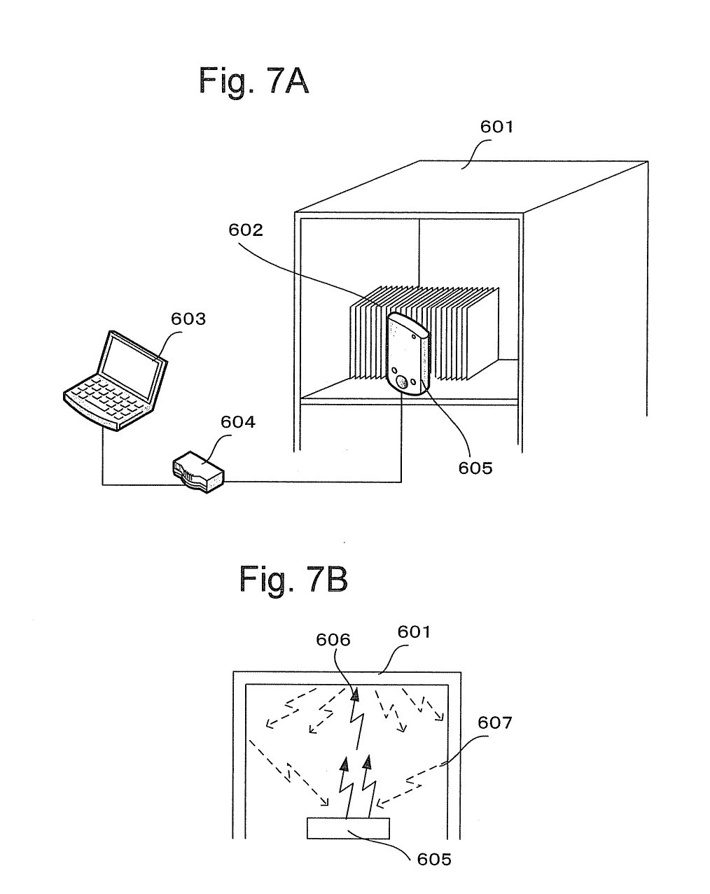

The present embodiment will be outlined. FIG. 6 is a block diagram illustrating how the wireless tag reader/writer antenna according to this embodiment is used.

The term “wireless tag” means a recording medium that can communicate by radio. Most wireless tags have an antenna and an IC chip, each. The wireless tag may further have a calculating function. Preferably, the wireless tag should have a portable size. Nonetheless, it may be much smaller. The wireless tag is known also as radio frequency identification (RFID).

The wireless tag 510 shown in FIG. 6 comprises a memory 511, a wireless tag control unit 512, a power generating unit 515, a modulating unit 513, and a demodulating unit 514. The memory 511 is a storage device. The wireless tag control unit 512 can write and read data into and from the memory 511. The power generating unit 515 rectifies and stabilizes any modulated electromagnetic wave received, thus generating power. The modulating unit 513 modulates the data supplied from the wireless tag control unit 512 and supplies the data to a wireless tag antenna 516. The demodulating unit 514 receives the modulated electromagnetic wave and demodulates the same. The wave demodulated is supplied to the wireless tag control unit 512.

The wireless tag reader/writer 520 comprises an antenna unit 521, a reader/writer control unit 526, a modulating unit 522, a transmission amplifier 523, a reception amplifier 524, a demodulating unit 525, and an interface 530. The antenna unit 521 incorporates a reader/writer antenna 521a that transmits and receives signals to and from wireless tags in the form of electromagnetic waves. The reader/writer control unit 526 controls the communication with the wireless tag 510 and the hardware connected to it. The modulating unit 522 modulates the data supplied from the reader/writer control unit 526. The transmission amplifier 523 amplifies a modulated signal and transmits the same to the reader/writer antenna 521a. The reception amplifier 524 amplifies any modulated electromagnetic wave received. The demodulating unit 525 demodulates any modulated signal received. The interface 530 is connected to a high-order apparatus 603, such as a personal computer, and receives and transmits data from and to the higher-order apparatus. The reader/writer control unit 526 has a CPU 527, a ROM 528, and a RAM 529. The ROM 528 and RAM 529 store various data items.

The antenna unit 521 may be a handy wireless tag reader/writer that is provided in one housing, together with the wireless tag reader/writer 520.

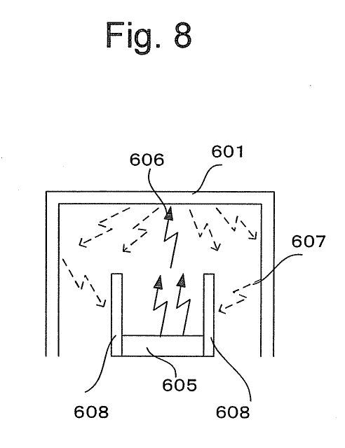

FIG. 8 shows the configuration of the wireless tag reader/writer antenna according to the present embodiment. The wireless tag reader/writer antenna according to this embodiment includes an antenna unit 605 and a plurality of electromagnetic-wave shields 608. The shields 608 are secured to the antenna unit 605, clamping the antenna unit 605, and extend in the direction of radiating electromagnetic waves from the antenna. As seen from FIG. 8, the electromagnetic-wave shields 608 can efficiently block electromagnetic waves 607 that are detrimental to communication.

### First Embodiment

<Configuration of Wireless Tag Reader/Writer Antenna of First Embodiment>

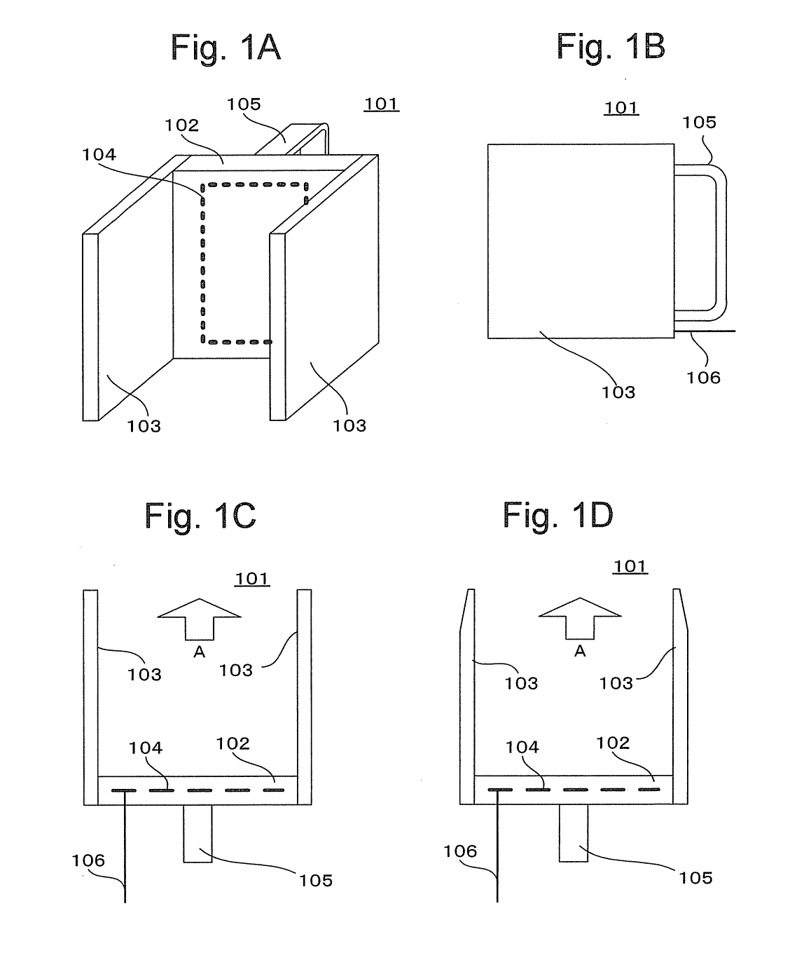

A first embodiment of the present invention will be described. FIGS. 1A to 1D show the configuration of a wireless tag reader/writer antenna 101 according to the first embodiment.

FIG. 1A is a perspective view of the wireless tag reader/writer antenna 101 according to the present embodiment. As FIG. 1A shows, the wireless tag reader/writer antenna 101 includes an antenna unit 102 and a plurality of electromagnetic-wave shields 103. The antenna unit 102 incorporates a reader/writer antenna 104 for transmitting and receiving signals in the form of electromagnetic waves, to and from wireless tags. The electromagnetic-wave shields 103 are secured to the antenna unit 102, clamping the antenna unit 102, and extend in the direction (arrow A) of radiating electromagnetic waves from the reader/writer antenna 104. The antenna unit 102 may further have a handle 105.

FIG. 1B is a side view of the wireless tag reader/writer antenna 101. As shown in FIG. 1B, the wireless tag reader/writer antenna 101 may have a wire 106 connected to a wireless tag reader/writer (not shown).

FIG. 1C is a top view of the wireless tag reader/writer antenna 101. As FIG. 1C shows, the electromagnetic-wave shields 103 extend in the direction of radiating electromagnetic waves from the reader/writer antenna 104.

FIG. 1D is another top view of the wireless tag reader/writer antenna 101. As FIG. 1D shows, the electromagnetic-wave shields 103 may have a wedge-shaped distal end, gradually thinner in the direction of radiating electromagnetic waves. The distal end of each electromagnetic-wave shield 103 may be rounded.

As shown in FIGS. 1A to 1D, two electromagnetic-wave shields 103 are secured to the left side of the antenna unit 102, and two other electromagnetic-wave shields 103 are secured to the right side thereof. The wireless tag reader/writer antenna 101 according to this embodiment may further has two electromagnetic-wave shields 103 above the antenna unit 102 and two electromagnetic-wave shields below the antenna unit 102, thus forming a hollow-cylindrical electromagnetic-wave shield. In this case, too, the same advantage can be acquired.

<Configuration of the Electromagnetic-Wave Shields of First Embodiment>

Various configurations that the electromagnetic-wave shields 103 may have will be described below.

### (First Configuration)

Each electromagnetic-wave shield 103 has an electromagnetic-wave absorbing layer on the side that contacts the antenna unit 102, and has an electromagnetic-wave reflecting metal layer on the side that faces away from the antenna unit 102.

The electromagnetic-wave reflecting metal layer is made of almost pure metal such as iron or copper or made of alloy such as stainless steel.

The electromagnetic-wave absorbing layer is made of, for example, synthetic resin, wood or cellulose. Alternatively, it may be made of any material that can efficiently absorb electromagnetic waves. The material capable of efficiently absorbing electromagnetic waves may be carbon-impregnated polyurethane, ferrite, or carbon-impregnated styrene foam. Nevertheless, the material is not limited to the ones exemplified here.

So configured, the electromagnetic-wave shields 103 can shield the wireless tag reader/writer from the electromagnetic waves coming from outside the wireless tag reader/writer antenna 101.

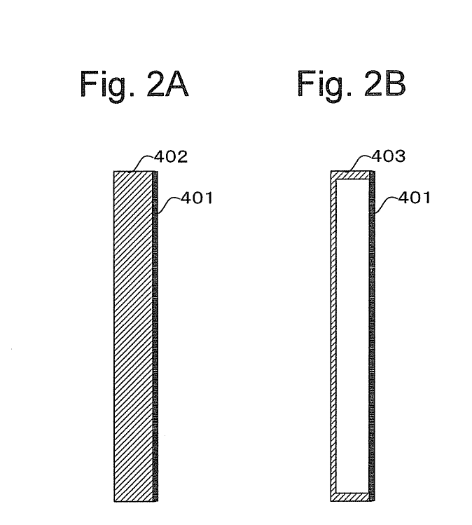

FIG. 2A is a sectional view of one of the electromagnetic-wave shields 103, as viewed from above. The electromagnetic-wave shield 103 has an inner side (i.e., left side in FIG. 2A) that contacts the antenna unit 102, and an outer side (i.e., right side in FIG. 2A). As shown in FIG. 2A, the electromagnetic-wave shield 103 comprises a metal layer 401 and an electromagnetic-wave absorbing layer 402 laid on the metal layer 401. The metal layer 401 uniformly reflects electromagnetic waves. As FIG. 2B shows, the electromagnetic-wave shield 103 may comprise a metal layer 401 and an electromagnetic-wave absorbing layer 403 made by molding. The electromagnetic-wave layer 403 has a hollow, which is closed by the metal layer 401 that reflects electromagnetic waves.

### (Second Configuration)

Each electromagnetic-wave shield 103 includes an electromagnetic-wave absorbing member. The electromagnetic-wave shield 103 may be composed of this electromagnetic-wave absorbing member only. Instead, it may have another electromagnetic-wave absorbing member on the inner side that contacts the antenna unit 102. This absorbing member is made of at least one of the wave-absorbing materials specified above.

### Advantages of the First Embodiment

As indicated above, the wireless tag reader/writer antenna 101 according to this embodiment includes a plurality of electromagnetic-wave shields 103. The shields 103 are secured to the antenna unit 102, clamping the antenna unit 102, and extend in the direction of radiating electromagnetic waves from the reader/writer antenna 104. Therefore, the shields 103 can efficiently block electromagnetic waves that are detrimental to the communication with wireless tags.

### Second Embodiment

<Configuration of Wireless Tag Reader/Writer Antenna of Second Embodiment>

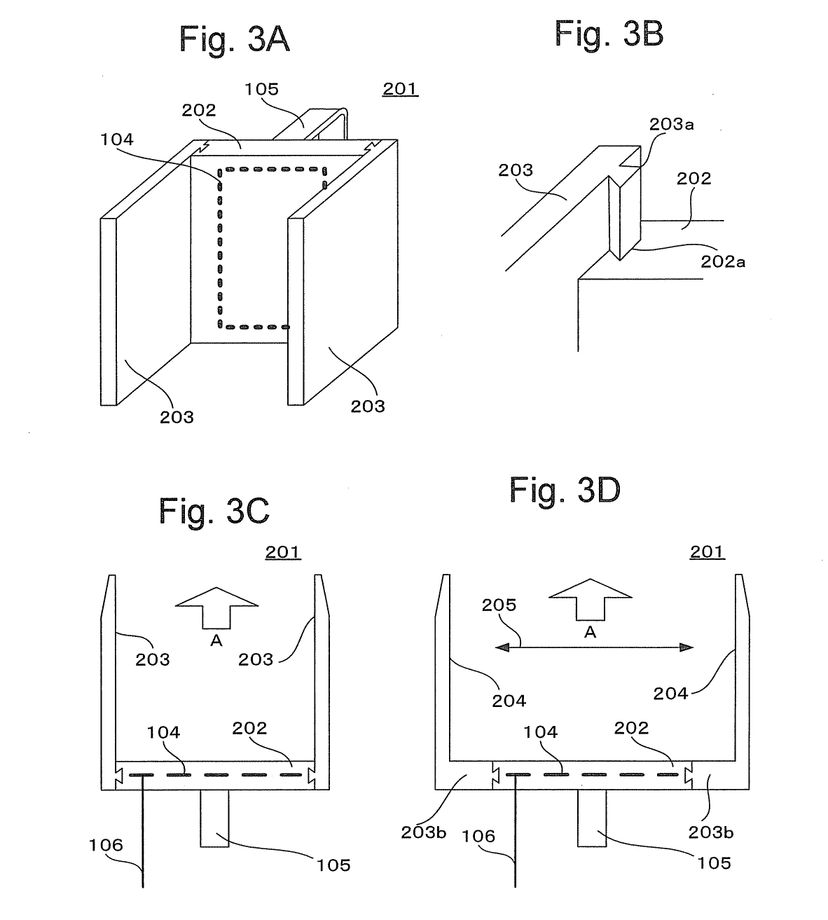

A second embodiment of the present invention will be described. FIGS. 3A to 3D show the configuration of a wireless tag reader/writer antenna 201 according to the second embodiment.

FIG. 3A is a perspective view of the wireless tag reader/writer antenna 201 according to the present embodiment. As FIG. 3A shows, the wireless tag reader/writer antenna 201 includes an antenna unit 202 and a plurality of electromagnetic-wave shields 203. The antenna unit 202 incorporates a reader/writer antenna 104 for transmitting and receiving signals in the form of electromagnetic waves, to and from wireless tags. The electromagnetic-wave shields 203 are secured to the antenna unit 202, clamping the antenna unit 202, and extend in the direction (arrow A) of radiating electromagnetic waves from the reader/writer antenna 104. The antenna unit 202 may further have a handle 105.

FIG. 3B is a magnified view of the junction of the antenna unit 202 and electromagnetic-wave shield 203, both provided in the antenna 201. Each electromagnetic-wave shield 203 and the antenna unit 202 are provided as components independent of each other, each being detachable. As FIG. 3B shows, the shields 203 have a projection 203a each. The projections 203a are fitted in the recesses 202a made in the antenna unit 202. The shields 203 are thereby secured to the antenna unit 202.

A rail-type attaching/detaching mechanism is shown in FIG. 3B. The mechanism for securing the electromagnetic-wave shields 203 to the antenna unit 202 is not limited to this type, nonetheless. A mechanism having screws can be employed instead.

In the wireless tag reader/writer antenna 201 according to the present embodiment, the electromagnetic-wave shields 203, which are secured to the antenna unit 202, may have different lengths as measured in the widthwise direction of the antenna unit 202. If this is the case, the number or thickness of articles that have wireless tags, with which the wireless tag reader/writer antenna 201 can communicate at a time, can be changed merely by selectively using the electromagnetic-wave shields 203 of different lengths.

FIG. 3C is a top view of the wireless tag reader/writer antenna 201. As shown in FIG. 3C, the electromagnetic-wave shields 203 have a fixing part each. The fixing part is relatively short as measured in the widthwise direction of the antenna unit 202.

FIG. 3D is a top view of another type of the wireless tag reader/writer antenna 201. The wireless tag reader/writer antenna 201 of this type has electromagnetic-wave shields 204, each having a fixing part 203b. The fixing part 203b is relatively long as measured in the widthwise direction 205 of the antenna unit 202.

The widthwise direction 205 of the antenna unit 202 is the distance by which the two electromagnetic-wave shields 204 clamping the antenna unit 202 are spaced apart from each other.

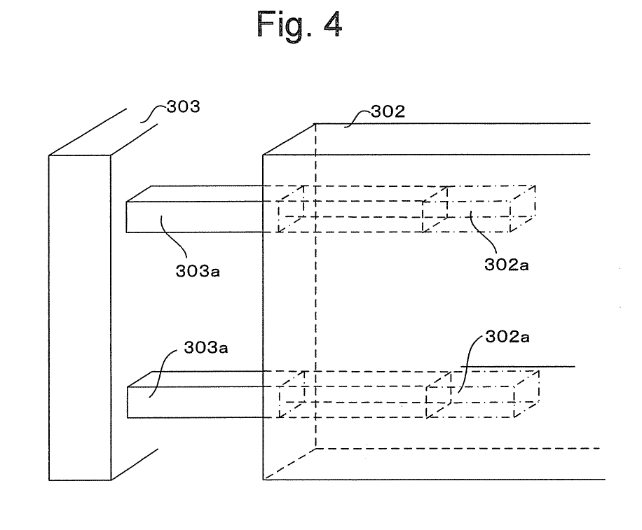

Another configuration that the wireless tag reader/writer antenna 201 according to the second embodiment may have will be described. FIG. 4 is a magnified view of the junction of the antenna unit 302 and the fixing parts of the electromagnetic-wave shield 303.

As FIG. 4 shows, the wireless tag reader/writer antenna 201 includes an antenna unit 302 and a plurality of electromagnetic-wave shields 303. The antenna unit 302 incorporates a reader/writer antenna for transmitting and receiving signals in the form of electromagnetic waves, to and from wireless tags. The electromagnetic-wave shields 303 are secured to the antenna unit 302, clamping the antenna unit 302, can slide in the widthwise direction of the antenna unit 302, and extend in the direction of radiating electromagnetic waves from the reader/writer antenna.

In the configuration of FIG. 4, each electromagnetic-wave shield 303 has two slide arms 303a. The slide arms 303a are inserted in the two slide-arm holes 302a made in the antenna unit 302, respectively, and can slide in these holes 302a. (Note that part of each slide arm 303a, which is inserted in the hole 302a, is indicated by broken lines.) The electromagnetic-wave shield 303 can therefore slide in the widthwise direction of the antenna unit 302. This can change the number or thickness of articles that have wireless tags, with which the wireless tag reader/writer antenna 201 can communicate at a time.

The method of connecting the electromagnetic-wave shields 303 to the antenna unit 302 is not limited to the one explained with reference to FIG. 4. The electromagnetic-wave shields 303 may be connected to the antenna unit 302 in any other method.

<Configuration of the Electromagnetic-Wave Shields of Second Embodiment>

The electromagnetic-wave shields of the second embodiment can have the configuration of the electromagnetic-wave shields of the first embodiment described above.

### Advantages of the Second Embodiment

As described above, the wireless tag reader/writer antenna 201 according to this embodiment includes a plurality of electromagnetic-wave shields 203 which clamp the antenna unit 202, which can slide in the widthwise direction 205 of the antenna unit 202 and which extend in the direction of radiating electromagnetic waves from the reader/writer antenna 104. Hence, the electromagnetic-wave shields 203 can be detached if there are scarcely electromagnetic waves detrimental to the communication with the wireless tags. Thus, the number or thickness of articles that have wireless tags, with which the wireless tag reader/writer antenna 201 can communicate at a time, can be changed, if necessary, at high efficiency, only by replacing the electromagnetic-wave shields 203 with other shields.

### Third Embodiment

<Configuration of Wireless tag Reader/Writer Antenna of Third Embodiment>

A third embodiment of the present invention will be described.

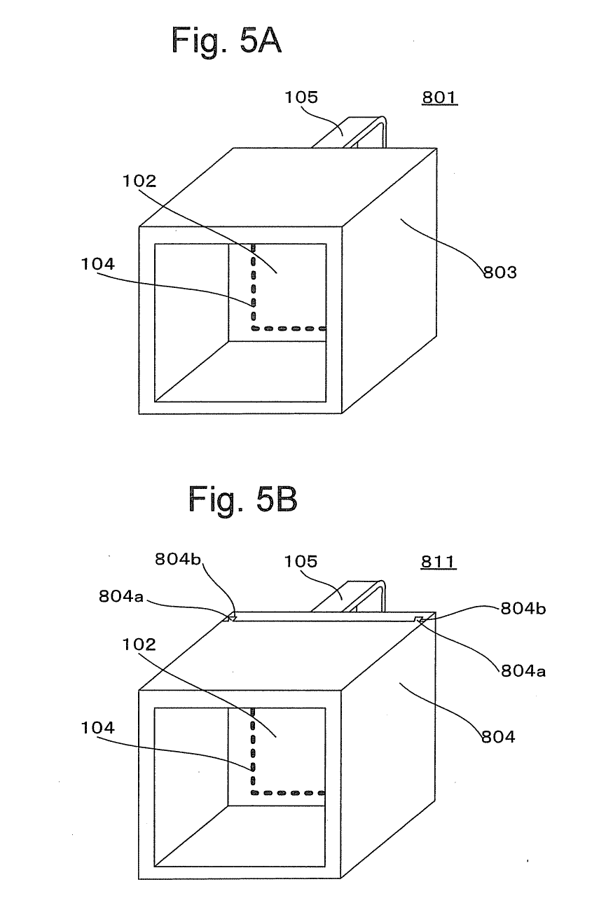

FIG. 5A is a perspective view of a wireless tag reader/writer antenna 801 according to the third embodiment. As FIG. 5A shows, the antenna 801 includes an antenna unit 102 and an electromagnetic-wave shield 803. The antenna unit 102 incorporates a reader/writer antenna 104 for transmitting and receiving electromagnetic waves to and from wireless tags. The electromagnetic-wave shield 803 is shaped like a hollow cylinder. The shield 803 is secured to the antenna unit 102 such that its open bottom contacts the wave-radiating surface of the antenna unit 102 or surrounds the outer circumference of the antenna unit 102. The shield 803 extends in the direction of radiating electromagnetic waves from the reader/writer antenna 104.

In FIG. 5A, the electromagnetic-wave shield 803 is illustrated as a hollow cylinder having a square cross section. Nonetheless, the shield 803 may have a circular cross section or a polygonal cross section.

FIG. 5B is a perspective view of another type of a wireless tag reader/writer antenna 811 according to the present embodiment. In the wireless tag reader/writer antenna 811, the hollow-cylindrical electromagnetic-wave shield 804 is detachably secured to the antenna unit 102, with its open bottom contacting the antenna unit 102. That is, the shield 804 is a member not integral with the antenna unit 102.

To render the electromagnetic-wave shield 804 detachable from the antenna unit 102, the attaching/detaching mechanism shown in FIG. 3B, for example, can be used. That is, the electromagnetic-wave shield 804 has projections 804a, which are fitted in the recesses 804b made in the antenna unit 102, whereby the shield 804 is secured to the antenna unit 102. The attaching/detaching mechanism is not limited to this, nevertheless. A mechanism having screws can be employed instead.

<Configuration of the Electromagnetic-Wave Shield of Third Embodiment>

The electromagnetic-wave shield of the third embodiment can have the configuration of the electromagnetic-wave shields of the first embodiment described above.

### Advantages of the Third Embodiment

As described above, the wireless tag reader/writer antenna 801 according to this embodiment includes an electromagnetic-wave shield 803 which is shaped like a hollow cylinder having an open bottom, which is secured to the antenna unit 102, with the open bottom contacting the wave-radiating surface of the antenna unit 102, and which extends in the direction of radiating electromagnetic waves from the reader/writer antenna 104. Moreover, the shield 803 can be detachably secured to the antenna unit 102. The shield 803 can therefore efficiently block electromagnetic waves that are detrimental to the communication with wireless tags.

### <Feasibility of the Present Invention>

It should be noted that the present invention is not limited to the various embodiments described above. The components of any embodiment can be modified in various manners in reducing the invention to practice, without departing from the spirit or scope of the invention. Further, the components of the embodiments described above may be combined, if necessary, in appropriate ways, thereby to make different inventions. Still further, some of the components of any embodiment may not be used. Moreover, the components of the different embodiments may be combined in any desired fashion.

What is claimed is:

1. A wireless tag reader/writer antenna comprising:
an antenna unit that incorporates a reader/writer antenna for transmitting and receiving electromagnetic waves to and from wireless tags; and
a plurality of magnetic-wave shields that clamp the antenna unit and extend in a direction of radiating electromagnetic waves from the reader/writer antenna.

2. The wireless tag reader/writer antenna according to claim 1, wherein the magnetic-wave shields have an electromagnetic-wave absorbing layer on that side which faces the antenna unit, and includes an electromagnetic-wave reflecting metal layer on that side which faces away from the antenna unit.

3. The wireless tag reader/writer antenna according to claim 1, wherein the magnetic-wave shields include an electromagnetic-wave absorbing member including an electromagnetic-wave absorbing layer.

4. The wireless tag reader/writer antenna according to claim 3, wherein the electromagnetic-wave absorbing layer is made of at least one material selected from the group consisting of carbon-impregnated polyurethane, ferrite, and carbon-impregnated styrene foam.

5. A wireless tag reader/writer antenna comprising:
an antenna unit that incorporates a reader/writer antenna for transmitting and receiving electromagnetic waves to and from wireless tags; and
a plurality of magnetic-wave shields that are detachably secured to the antenna unit, clamping the antenna unit, and extend in a direction of radiating electromagnetic waves from the reader/writer antenna.

6. The wireless tag reader/writer antenna according to claim 5, wherein the magnetic-wave shields have a fixing parts each, which is secured to the antenna unit, the fixing parts of the shields being different in length measured in a widthwise direction of the antenna unit.

7. The wireless tag reader/writer antenna according to claim 6, wherein the magnetic-wave shields have an electromagnetic-wave absorbing layer on that side which faces the antenna unit, and includes an electromagnetic-wave reflecting metal layer on that side which faces away from the antenna unit.

8. The wireless tag reader/writer antenna according to claim 6, wherein the magnetic-wave shields include an electromagnetic-wave absorbing member including an electromagnetic-wave absorbing layer.

9. The wireless tag reader/writer antenna according to claim 8, wherein the electromagnetic-wave absorbing layer is made of at least one material selected from the group consisting of carbon-impregnated polyurethane, ferrite, and carbon-impregnated styrene foam.

10. A wireless tag reader/writer antenna comprising:
an antenna unit that incorporates a reader/writer antenna for transmitting and receiving electromagnetic waves to and from wireless tags; and
a plurality of magnetic-wave shields that are secured to the antenna unit, clamping the antenna unit, are able to slide in a widthwise direction of the antenna unit, and extend in a direction of radiating electromagnetic waves from the reader/writer antenna.

11. The wireless tag reader/writer antenna according to claim 10, wherein the magnetic-wave shields have a fixing parts each and are detachably secured to the antenna unit, the fixing parts of the shields being different in length measured in a widthwise direction of the antenna unit.

12. The wireless tag reader/writer antenna according to claim 11, wherein the magnetic-wave shields have an electromagnetic-wave absorbing layer on that side which faces the antenna unit, and includes an electromagnetic-wave reflecting metal layer on that side which faces away from the antenna unit.

13. The wireless tag reader/writer antenna according to claim 12, wherein the magnetic-wave shields include an electromagnetic-wave absorbing member including an electromagnetic-wave absorbing layer.

14. The wireless tag reader/writer antenna according to claim 13, wherein the electromagnetic-wave absorbing layer is made of at least one material selected from the group consisting of carbon-impregnated polyurethane, ferrite, and carbon-impregnated styrene foam.

15. A wireless tag reader/writer antenna comprising:
an antenna unit that incorporates a reader/writer antenna for transmitting and receiving electromagnetic waves to and from wireless tags; and
a magnetic-wave shield that is shaped like a hollow cylinder having an open bottom, is secured to the antenna unit, contacting, at the open bottom, an
electromagnetic-wave radiating surface of the antenna unit or surrounding an outer circumference of the antenna unit, and extends in a direction of radiating electromagnetic waves from the reader/writer antenna.

16. The wireless tag reader/writer antenna according to claim 15, wherein the magnetic-wave shield is detachably secured to the antenna unit.

17. The wireless tag reader/writer antenna according to claim 16, wherein the magnetic-wave shield has an electromagnetic-wave absorbing layer on that side which faces the antenna unit, and includes an electromagnetic-wave reflecting metal layer on that side which faces away from the antenna unit.

18. The wireless tag reader/writer antenna according to claim 16, wherein the magnetic-wave shield includes an electromagnetic-wave absorbing member including an electromagnetic-wave absorbing layer.

19. The wireless tag reader/writer antenna according to claim 18, wherein the electromagnetic-wave absorbing layer is made of at least one material selected from the group consisting of carbon-impregnated polyurethane, ferrite, and carbon-impregnated styrene foam.
